(19) United States
(12) Patent Application Publication
(10) Pub. No.: US 2019/0187931 A1
(43) Pub. Date: Jun. 20, 2019

(54) DATA PROCESSING SYSTEM AND OPERATING METHOD THEREOF

(71) Applicant: SK hynix Inc., Gyeonggi-do (KR)

(72) Inventor: Eu-Joon BYUN, Gyeonggi-do (KR)

(21) Appl. No.: 16/035,030

(22) Filed: Jul. 13, 2018

(30) Foreign Application Priority Data
Dec. 19, 2017 (KR) 10-2017-0175010

(51) Int. Cl. G06F 3/06; G06F 12/0804

(52) U.S. Cl. CPC G06F 3/0659; G06F 3/0604; G06F 2212/1041; G06F 12/0804; G06F 3/0679

(57) ABSTRACT

A semiconductor memory system includes: a memory device including a first memory region and a second memory region; and a controller suitable for: merging a plurality of write commands, controlling the memory device to perform a write operation of storing a plurality of data corresponding to the merged write commands into the first memory region in a normal mode, and controlling the memory device to perform a write operation of storing data corresponding to each of the plurality of write commands into the second memory region in a boost mode.

### CROSS-REFERENCE TO RELATED APPLICATIONS

The present application claims priority under 35 U.S.C. § 119(a) to Korean Patent Application No. 10-2017-0175010, filed on Dec. 19, 2017, the disclosure of which is incorporated herein by reference in its entirety.

### BACKGROUND

### 1. Field

Various exemplary embodiments of the invention relate to a semiconductor memory system and more particularly a memory system capable of dynamically a write mode, and an operating method thereof.

### 2. Description of the Related Art

The computer environment paradigm has been moved to ubiquitous computing, which can support computing made to appear anytime and anywhere. The use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption since they have no moving parts (e.g., a mechanical arm with a read/write head) as compared with a hard disk device. Examples of memory systems having such advantages include universal serial bus (USB) memory devices, memory cards having various interfaces, and solid state drives (SSD).

### SUMMARY

Various embodiments of the present disclosure are directed to a semiconductor memory system and more particularly a memory system capable of dynamically determining a write mode, and an operating method thereof.

In accordance with an embodiment of the present invention, a semiconductor memory system comprising: a memory device including a first memory region and a second memory region; and a controller suitable for: merging a plurality of write commands, controlling the memory device to perform a write operation of storing a plurality of data corresponding to the merged write commands into the first memory region in a normal mode, and controlling the memory device to perform a write operation of storing data corresponding to each of the plurality of write commands into the second memory region in a boost mode.

The controller may include a write mode unit, and the write mode unit may be suitable for determining one between the boost mode and the normal mode according to a write mode result obtained from a write mode parameter table.

The write mode parameter table may have as parameters for output of the write mode result: a flush command count indicating how many times an operation corresponding to a flush command is completed; a dummy data size indicating how many dummy data are required for the write operation, corresponding to the merged write commands, performed in either the first memory region or the second memory region; and a required write performance indicating whether the reliability of the data to be written is high.

The write mode unit may determine the boost mode when one or more among the parameters for output of the write mode result have predetermined thresholds or more, and determine the normal mode when all of the parameters for output of the write mode result have less values than the predetermined thresholds.

The write mode unit may control a flag corresponding to the flush command count to have a logical high value in the write mode parameter table when the flush command count is a predetermined threshold or more, and control the flag corresponding to the flush command count to have a logical low value in the write mode parameter table when the flush command count is less than the predetermined threshold.

The write mode unit may control a flag corresponding to the dummy data size to have a logical high value in the write mode parameter table when the dummy data size is a predetermined threshold or more, and control the flag corresponding to the dummy data size to have a logical low value in the write mode parameter table when the dummy data size is less than the predetermined threshold.

The write mode unit may control a flag corresponding to the required write performance to have a logical high value in the write mode parameter table when the required write performance is a predetermined threshold or more, and control the flag corresponding to the required write performance to have a logical low value in the write mode parameter table when the required write performance is less than the predetermined threshold.

The write mode unit may control a flag corresponding to the write mode result to have a resultant logic value of an OR operation to logic values of flags included in the write mode parameter table.

The first memory region may include memory cells between multi-level memory cells (MLCs) and triple level memory cells (TLCs), and the second memory region may include single level memory cells (SLCs).

In accordance with an embodiment of the present invention, an operating method of a semiconductor memory system includes: merging a plurality of write commands, and controlling a memory device to perform a write operation of storing a plurality of data corresponding to the merged write commands into a first memory region included in the memory device in a normal mode, and controlling the memory device to perform a write operation of storing data corresponding to each of the plurality of write commands into a second memory region included in the memory device in a boost mode.

The operating method may further comprise determining one between the boost mode and the normal mode according to a write mode result obtained from a write mode parameter table.

The write mode parameter table may have as parameters for output of the write mode result: a flush command count indicating how many times an operation corresponding to a flush command is completed; a dummy data size indicating how many dummy data are required for the write operation, corresponding to the merged write commands, performed in either the first memory region or the second memory region; and a required write performance indicating whether the reliability of the data to be written is high.

The determining of one between the boost mode and the normal mode may include: determining the boost mode when one or more among the parameters for output of the write mode result have predetermined thresholds or more; and determining the normal mode when all the parameters for output of the write mode result have less values than the predetermined thresholds.

The determining of one between the boost mode and the normal mode may include: controlling a flag corresponding to the flush command count to have a logical high value in the write mode parameter table when the flush command count is a predetermined threshold or more; and controlling the flag corresponding to the flush command count to have a logical low value in the write mode parameter table when the flush command count is less than the predetermined threshold.

The determining of one between the boost mode and the normal mode may include: controlling a flag corresponding to the dummy data size to have a logical high value in the write mode parameter table when the dummy data size is a predetermined threshold or more, and controlling the flag corresponding to the dummy data size to have a logical low value in the write mode parameter table when the dummy data size is less than the predetermined threshold.

The determining of one between the boost mode and the normal mode may include: controlling a flag corresponding to the required write performance to have a logical high value in the write mode parameter table when the required write performance is a predetermined threshold or more, and controlling the flag corresponding to the required write performance to have a logical low value in the write mode parameter table when the required write performance is less than the predetermined threshold.

The determining of one between the boost mode and the normal mode may include controlling a flag corresponding to the write mode result to have a resultant logic value of an OR operation to logic values of flags included in the write mode parameter table.

The first memory region may include memory cells between multi-level memory cells (MLCs) and triple level memory cells (TLCs), and the second memory region may include single level memory cells (SLCs).

In accordance with an embodiment of the present invention, a memory system includes a memory device including a first memory region and a second memory region, which have different structures from each other; and a controller suitable for dynamically determining a mode for a write operation in response to an entered write command with a data, wherein the mode is determined based on at least one parameter set when a plurality of write commands are merged.

### BRIEF DESCRIPTION OF THE DRAWINGS

FIG. 1 is a block diagram illustrating a data processing system including a memory system in accordance with an embodiment of the disclosure.

FIG. 2 is a schematic diagram illustrating an exemplary configuration of a memory device employed in the memory system of FIG. 1.

FIG. 3 is a circuit diagram illustrating an exemplary configuration of a memory cell array of a memory block in the memory device shown in FIG. 1.

FIG. 4 is a block diagram illustrating an exemplary three-dimensional structure of the memory device shown in FIG. 2.

FIG. 5A is a diagram illustrating a memory system in accordance with an embodiment of the disclosure.

FIG. 5B is a diagram illustrating a write mode parameter table in accordance with an embodiment of the disclosure.

FIG. 6 is a flowchart illustrating an operating method of a memory system in accordance with an embodiment of the disclosure.

FIGS. 7 to 15 are diagrams schematically illustrating application examples of the data processing system, in accordance with various embodiments of the disclosure.

### DETAILED DESCRIPTION

Various embodiments of the invention are described below in more detail with reference to the accompanying drawings. We note, however, that the invention may be embodied in different other embodiments, forms and variations thereof and should not be construed as being limited to the embodiments set forth herein. Rather, the described embodiments are provided so that this disclosure will be thorough and complete, and will fully convey the invention to those skilled in the art to which this invention pertains. Throughout the disclosure, like reference numerals refer to like parts throughout the various figures and embodiments of the invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate various features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for describing particular embodiments only and is not intended to be limiting of the invention. As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the invention belongs in view of the disclosure. It will be further understood that terms, such as those defined in commonly used dictionaries, should be interpreted as having a meaning that is consistent with their meaning in the context of the disclosure and the relevant art and will not be interpreted in an idealized or overly formal sense unless expressly so defined herein.

In the following description, numerous specific details are set forth in order to provide a thorough understanding of the present invention. The invention may be practiced without some or all of these specific details. In other instances, well-known process structures and/or processes have not been described in detail in order not to unnecessarily obscure the invention.

It is also noted, that in some instances, as would be apparent to those skilled in the relevant art, a feature or element described in connection with one embodiment may be used singly or in combination with other features or elements of another embodiment, unless otherwise specifically indicated.

Hereinafter, the various embodiments of the invention will be described in detail with reference to the attached drawings.

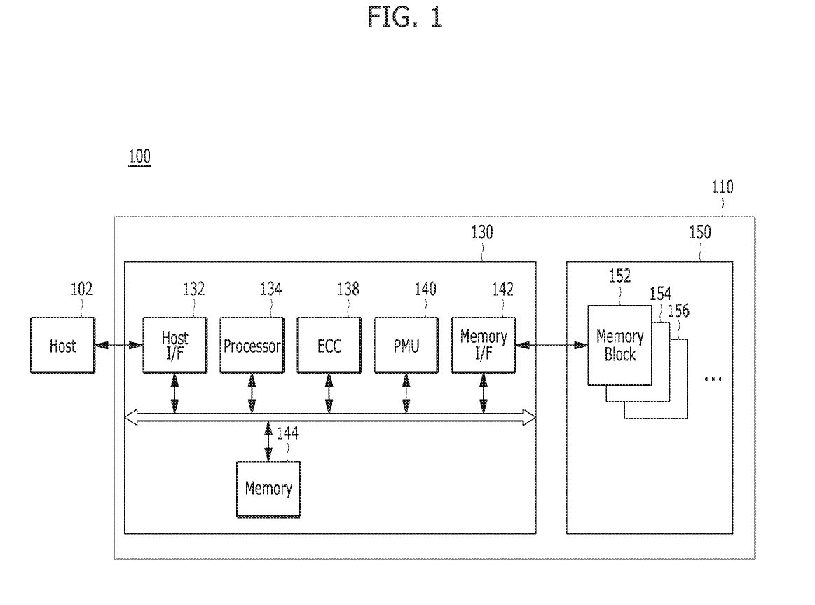

FIG. 1 is a block diagram illustrating a data processing system 100 including a memory system 110 in accordance with an embodiment of the invention.

Referring to FIG. 1, the data processing system 100 may include a host 102 electrically coupled to the memory system 110.

By the way of example but not limitation, the host 102 may include portable electronic devices such as a mobile phone, MP3 player and laptop computer or non-portable electronic devices such as a desktop computer, a game machine, a TV and a projector.

The host 102 may include at least one OS (operating system). The OS may manage and control overall functions and operations of the host 102. The OS may support provide an operation achieved between the host 102 and a user using the data processing system 100 or the memory system 110. The OS may support functions and operations requested by a user. By the way of example but not limitation, the OS may be divided into a general OS and a mobile OS, depending on whether it is customized for the mobility of the host 102. The general OS may be divided into a personal OS and an enterprise OS, depending on the environment of a user. For example, the personal OS configured to support a function of providing a service to general users may include Windows and Chrome, and the enterprise OS configured to secure and support high performance may include Windows server, Linux and Unix. Furthermore, the mobile OS configured to support a customized function of providing a mobile service to users and a power saving function of a system may include Android, iOS and Windows Mobile. The host 102 may include a plurality of Oss. The host 102 may execute an OS to perform an operation corresponding to a user's request on the memory system 110. Here, the host 102 may provide a plurality of commands corresponding to a user's request to the memory system 110. The memory system 110 may perform certain operations corresponding to the plurality of commands, that is, corresponding to the user's request.

The memory system 110 may operate to store data for the host 102 in response to a request of the host 102. Non-limited examples of the memory system 110 may include a solid state drive (SSD), a multi-media card (MMC), a secure digital (SD) card, a universal storage bus (USB) device, a universal flash storage (UFS) device, a compact flash (CF) card, a smart media card (SMC), a personal computer memory card international association (PCMCIA) card, and a memory stick. The MMC may include an embedded MMC (eMMC), a reduced size MMC (RS-MMC) and a micro-MMC, and the. The SD card may include a mini-SD card and a micro-SD card.

The memory system 110 may include various types of storage devices. Non-limited examples of storage devices included in the memory system 110 may include volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM) and a flash memory.

The memory system 110 may include a memory device 150 and a controller 130. The memory device 150 may store data for the host 102, while the controller 130 may control data storage into the memory device 150.

The controller 130 and the memory device 150 may be integrated into a single semiconductor device, which may be included in the various types of memory systems as described above. By the way of example but not limitation, the controller 130 and the memory device 150 may be integrated as a single semiconductor device to constitute an SSD. When the memory system 110 is used as an SSD, the operating speed of the host 102 connected to the memory system 110 can be improved. In another example, the controller 130 and the memory device 150 may be integrated as a single semiconductor device to constitute a memory card. By the way of example but not limitation, the controller 130 and the memory device 150 may constitute a memory card such as a PCMCIA (personal computer memory card international association) card, a CF card, a SMC (smart media card), a memory stick, an MMC including a RS-MMC and a micro-MMC, a SD card including a mini-SD, a micro-SD and a SDHC, an UFS device or the like.

The memory system 110 may be available for a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

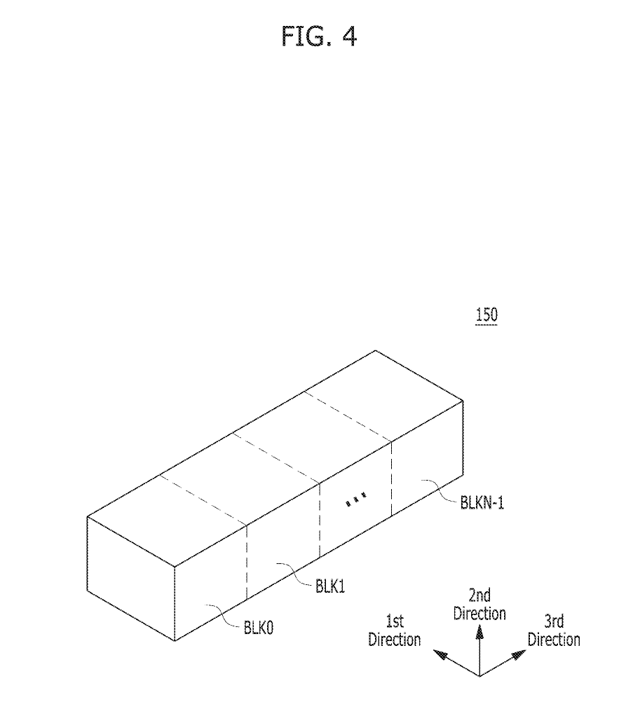

The memory device 150 may be a nonvolatile memory device which may retain stored data even though power is not supplied. The memory device 150 may store data provided from the host 102 through a write operation, while outputting data stored therein to the host 102 through a read operation. In an embodiment, the memory device 150 may include a plurality of memory dies (not shown), each memory may include a plurality of planes (not shown), each plane may include a plurality of memory blocks 152 to 156, each of the memory blocks 152 to 156 may include a plurality of pages, and each of the pages may include a plurality of memory cells coupled to a word line. In an embodiment, the memory device 150 may be a flash memory having a 3-dimensional (3D) stack structure, which will be described in more detail with reference to FIG. 4 below.

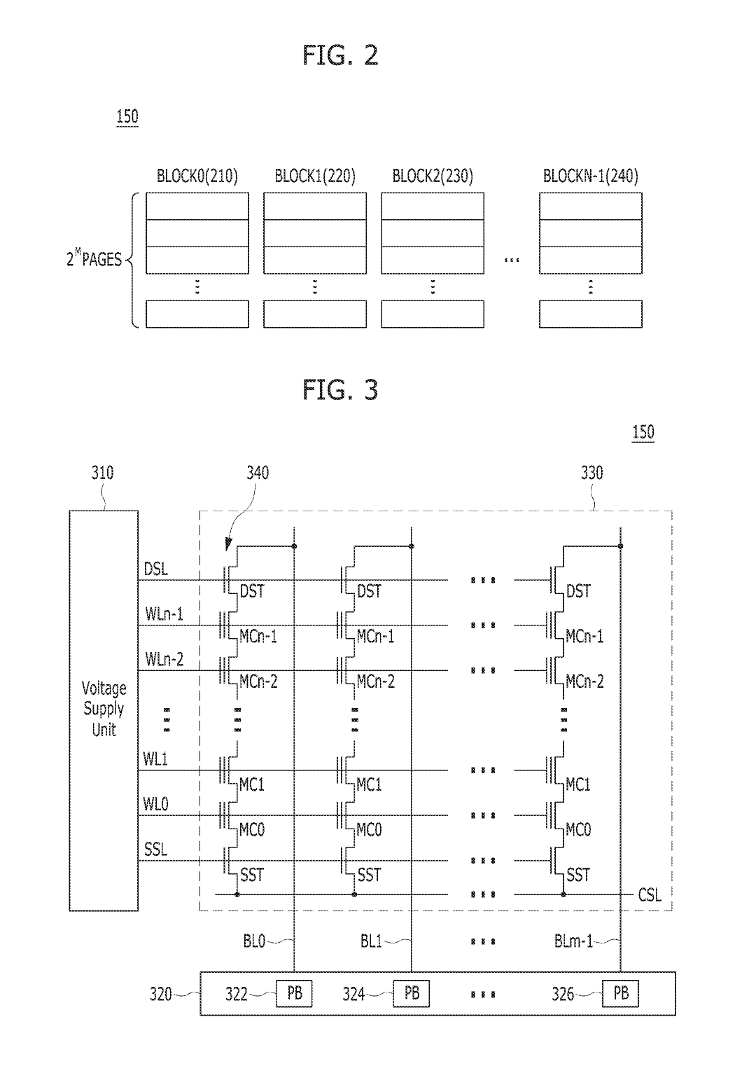

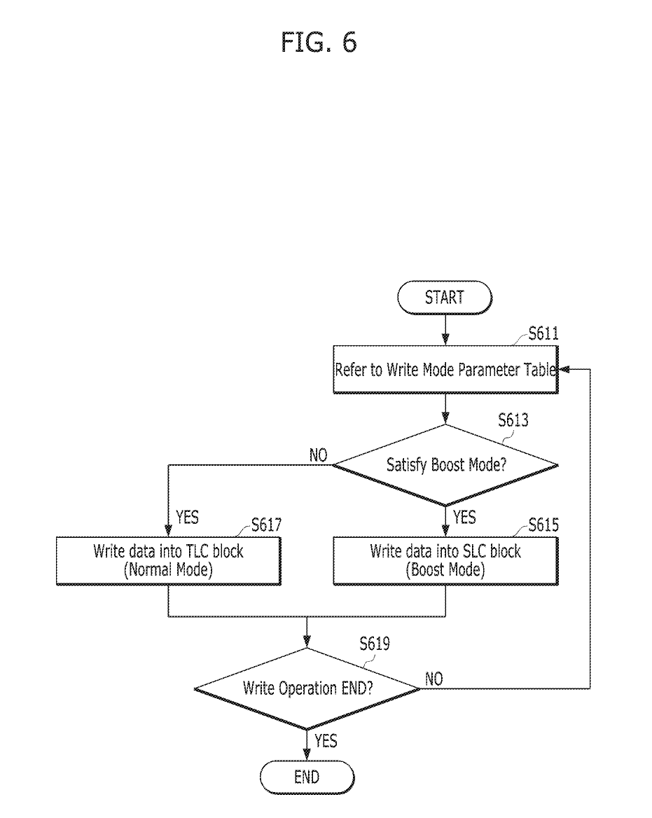

The structure of the memory device 150 and the 3D stack structure of the memory device 150 will be described in detail later with reference to FIGS. 2 to 4. The memory device 150, including a plurality of memory dies, each memory die including a plurality of planes, each plane including a plurality of memory blocks 152 to 156, will be described in detail later with reference to FIG. 6, further description on them will be omitted herein. Accordingly, overlapping descriptions will be omitted herein.

The controller 130 may control the memory device 150 in response to a request from the host 102. Specifically, the controller may control a read operation, a write operation (also referred to as a program operation), and an erase operation of the memory device 150. By the way of example but not limitation, the controller 130 may provide a data, read from the memory device 150, to the host 102, and store another data, entered from the host 102, into the memory device 150.

The controller 130 may include a host interface (I/F) unit 132, a processor 134, an error correction code (ECC) unit 138, a Power Management Unit (PMU) 140, a memory interface unit 142 such as a NAND flash controller, and a memory 144, each electrically coupled with each other via an internal bus.

The host interface unit 132 may be configured to process a command and data of the host 102. The host interface unit 132 may communicate with the host 102 under one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATA), enhanced small disk interface (ESDI) and integrated drive electronics (IDE). The host interface unit 132 may be controlled by, or implemented in, a firmware such as a host interface layer (HIL) for exchanging data with the host 102.

The ECC unit 138 may correct error bits of data to be processed by the memory device 150 and may include an ECC encoder and an ECC decoder. The ECC encoder may perform an error correction encoding onto data, which may be programmed into the memory device 150, to generate data to which a parity bit is added. The data with the parity bit may be stored in the memory device 150. The ECC decoder may detect, and correct, an error contained in the data read from the memory device 150. In other words, when the error may be detected, the ECC unit 138 may perform an error correction decoding process onto the data read from the memory device 150 through an ECC code used during an ECC encoding process. According to a result of the error correction decoding process, the ECC unit 138 may output a signal, e.g., an error correction success/fail signal. When the number of error bits is more than a threshold value of correctable error bits, the ECC unit 138 may not correct the error bits. The ECC unit 138 may output an error correction fail signal.

By the way of example but not limitation, the ECC unit 138 may perform error correction through a coded modulation based on a Low Density Parity Check (LDPC) code, a Bose-Chaudhri-Hocquenghem (BCH) code, a turbo code, a Reed-Solomon code, convolution code, a Recursive Systematic Code (RSC), a Trellis-Coded Modulation (TCM) and a Block coded modulation (BCM). However, the ECC unit 138 is not limited thereto. The ECC unit 138 may include other relevant circuits, modules, systems or devices for use in error correction.

The PMU 140 may manage an electrical power used and provided in the controller 130.

The memory interface unit 142 may work as a memory/storage interface for providing an interface between the controller 130 and the memory device 150 such that the controller 130 may control the memory device 150 in response to a request from the host 102. When the memory device 150 is a flash memory or specifically a NAND flash memory, the memory interface unit 142 may be NAND flash controller (NFC). The memory interface unit 142 may generate a control signal for the memory device 150 to provide data into the memory device 150 under the control of the processor 134. The memory interface unit 142 may work as an interface (e.g., a NAND flash interface) for processing a command and data between the controller 130 and the memory device 150. Specifically, the memory interface unit 142 may support data transfer between the controller 130 and the memory device 150. The memory interface unit 142 may include a firmware, that is, a flash interface layer (FIL) for exchanging data with the memory device 150.

The memory 144 may serve as a working memory of the memory system 110 and the controller 130. The memory 144 may store data for driving the memory system 110 and the controller 130. The controller 130 may control the memory device 150 to perform read, write, program, and erase operations in response to a request from the host 102. The controller 130 may output data read from the memory device 150 to the host 102. The controller 130 may store data, entered from the host 102, into the memory device 150. The memory 144 may store data required for the controller 130 and the memory device 150 to perform these operations.

The memory 144 may be embodied by a volatile memory. By the way of example but not limitation, the memory 144 may be embodied by a static random access memory (SRAM) or a dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

As described above, the memory 144 may include a program memory, a data memory, a write buffer/cache, a read buffer/cache, a data buffer/cache and a map buffer/cache to store either some data, required to perform data write and read operations by the host 102 at the memory device 150, or other data required for the controller 130 and the memory device 150 to perform these operations.

The processor 134 may control the overall operations of the memory system 110. The processor 134 may use a firmware to control the overall operations of the memory system 110. The firmware may be referred to as flash translation layer (FTL). Also, the processor 134 may be realized as a microprocessor or a Central Processing Unit (CPU).

By the way of example but not limitation, the controller 130 may perform an operation requested by the host 102 in the memory device 150 through the processor 134, which may be implemented by a kind of microprocessor, a CPU, or the like. In other words, the controller 130 may perform a command operation corresponding to a command received from the host 102. Herein, the controller 130 may perform a foreground operation as the command operation corresponding to the command received from the host 102. By the way of example but not limitation, the foreground operation achieved by the controller 130 may include a program operation corresponding to a write command, a read operation corresponding to a read command, an erase operation corresponding to an erase command, and a parameter set operation corresponding to a set parameter command, or a set feature command as a set command.

Also, the controller 130 may perform a background operation on the memory device 150 through the processor 134, which may be implemented by a microprocessor or a CPU. Herein, the background operation performed on the memory device 150 may include an operation of copying and processing data stored in some memory blocks among the memory blocks 152 to 156 of the memory device 150 into other memory blocks, e.g., a garbage collection (GC) operation, an operation of performing swapping between the memory blocks 152 to 156 of the memory device 150 or between the data of the memory blocks 152 to 156, e.g., a wear-leveling (WL) operation, an operation of storing the map data stored in the controller 130 in the memory blocks 152 to 156 of the memory device 150, e.g., a map flush operation, or an operation of managing bad blocks of the memory device 150, e.g., a bad block management operation of detecting and processing bad blocks among the memory blocks 152 to 156 included in the memory device 150.

The processor 134 of the controller 130 may include a management unit (not illustrated) for performing a bad management operation of the memory device 150. The management unit may perform a bad block management operation of checking a bad block, in which a program fail occurs due to a characteristic of the memory device, for example, a NAND flash memory during a program operation, among the plurality of memory blocks 152 to 156 included in the memory device 150. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation performing with more reliability is needed.

FIG. 2 is a schematic diagram illustrating an exemplary configuration of the memory device 150 employed in the memory system 110 of FIG. 1.

Referring to FIG. 2, the memory device 150 may include a plurality of memory blocks BLOCK0 to BLOCKN−1, and each of the memory blocks BLOCK0 to BLOCKN−1 may include a plurality of pages, for example, 2^{M} pages, the number of which may vary depending on circuit design.

Also, memory cells included in the respective memory blocks BLOCK0 to BLOCKN−1 may be one or more of a single level cell (SLC) memory block storing 1-bit data or a multi-level cell (MLC) memory block storing 2-bit data. Hence, the memory device 150 may include SLC memory blocks or MLC memory blocks, depending on the number of bits which can be expressed or stored in each of the memory cells in the memory blocks. The SLC memory blocks may include a plurality of pages that are embodied by plural memory cells, each storing one-bit data. The SLC memory blocks may generally have high data computing performance and high durability. The MLC memory blocks may include a plurality of pages which are constituted with plural memory cells, each storing multi-bit data (for example, 2 or more bits). The MLC memory blocks may generally have a larger data storage space than the SLC memory block, that is, higher integration density. In another embodiment, the memory device 150 may include a plurality of triple level cell (TLC) memory blocks. The TCL memory blocks may include a plurality of pages which are embodied by plural memory cells, each capable of storing 3-bit data. In yet another embodiment, the memory device 150 may include a plurality of quadruple level cell (QLC) memory blocks. The QLC memory blocks may include a plurality of pages which are embodied by memory cells, each capable of storing 4-bit data. Although the embodiment of the disclosure exemplarily describes, for the sake of convenience in description, that the memory device 150 may be the nonvolatile memory, it may implemented by any one of a phase change random access memory (PCRAM), a resistive random access memory (RRAM(ReRAM)), a ferroelectrics random access memory (FRAM), and a spin transfer torque magnetic random access memory (STT-RAM(STT-MRAM)).

FIG. 3 is a circuit diagram illustrating an exemplary configuration of a memory cell array of a memory block 330 in the memory device 150. By the way of example but not limitation, the memory block 330 may correspond to any of the plurality of memory blocks 152 to 156 included in the memory device 150 of the memory system 110.

Referring to FIG. 3, the memory block 330 may include a plurality of cell strings 340 coupled to a plurality of corresponding bit lines BL0 to BLm−1. For reference, in FIG. 3, ‘DSL’ denotes a drain select line, ‘SSL’ denotes a source select line, and ‘CSL’ denotes a common source line. Each cell string 340 may be electrically coupled to a bit line BL, at least one source select line SSL, at least one ground select line GSL, a plurality of word lines WL, at least one dummy word line DWL, and a common source line CSL. The cell string 340 of each column may include one or more drain select transistors DST and one or more source select transistors SST. Between the drain and source select transistors DST and SST, a plurality of memory cells MC0 to MCn−1 may be coupled in series. In an embodiment, each of the memory cell transistors MC0 to MCn−1 may be implemented by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1.

Although FIG. 3 illustrates NAND flash memory cells, the disclosure is not limited thereto. It is noted that the memory cells may be NOR flash memory cells, or hybrid flash memory cells including two or more types of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply unit 310 which provides word line voltages including a program voltage, a read voltage, and a pass voltage to supply to the word lines according to an operation mode. The program voltage, the read voltage and the pass voltage may have different voltage levels for their functions. The voltage generation operation of the voltage supply unit 310 may be controlled by a control circuit (not illustrated). Under the control of the control circuit, the voltage supply unit 310 may select one of the memory blocks (or sectors) of the memory cell array. The voltage supply unit 310 may select one of the word lines of the selected memory block. The voltage supply unit 310 may provide different word line voltages to the selected word line and the unselected word lines as may be required for a specific operation.

The memory device 150 may include a read/write circuit 320 which Is controlled by the control circuit. During a verification/normal read operation, the read/write circuit 320 may operate as a sense amplifier for reading data from the memory cell array. During a program operation, the read/write circuit 320 may operate as a write driver for controlling a level of current flowing through bit lines according to data to be stored in the memory cell array. During a program operation, the read/write circuit 320 may receive from a buffer (not illustrated) data to be stored into the memory cell array. The read/write circuit 320 may control a level of current flowing through bit lines according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

FIG. 4 is a schematic diagram illustrating an exemplary 3D structure of the memory device 150.

The memory device 150 may be embodied by a 2D or 3D memory device. Particularly, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1, each having a 3D structure (or vertical structure).

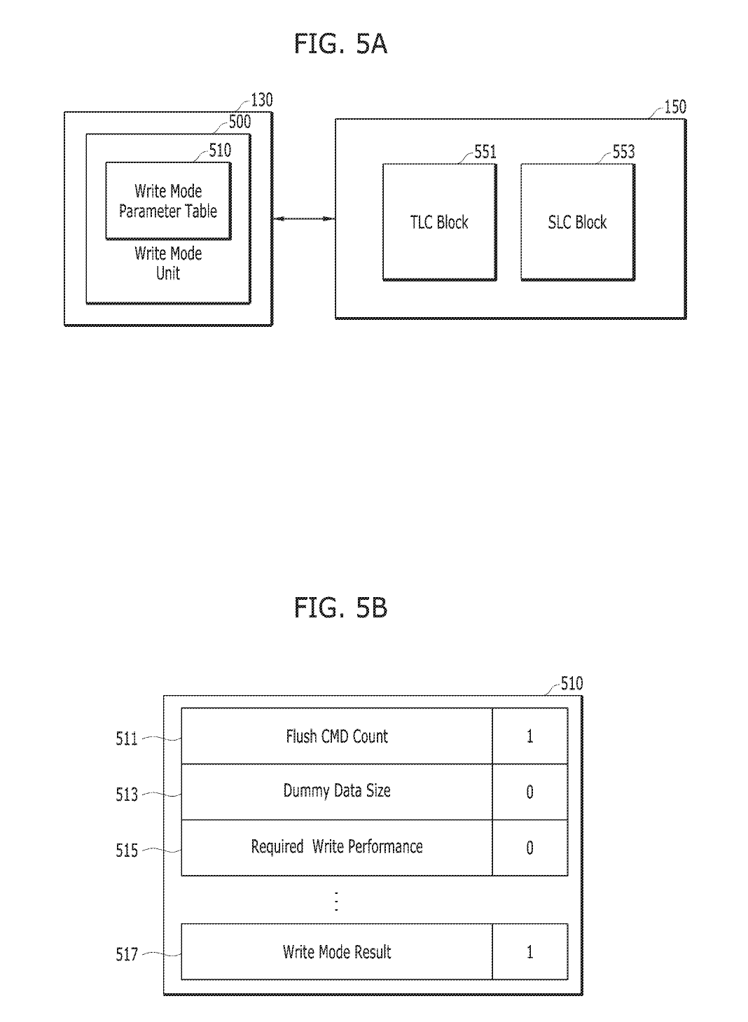

Hereafter, a data processing operation for a memory device, particularly, a data processing operation performed when a plurality of command operations corresponding to a plurality of commands entered from the host 102 are performed, in a memory system in accordance with an embodiment of the disclosure, will be described in detail with reference to FIGS. 5A to 6.

FIG. 5A is a diagram illustrating a memory system including a write mode unit capable of dynamically determining a write mode in accordance with an embodiment of the disclosure.

The controller 130 may include a write mode unit 500. The write mode unit 500 may be implemented with a hardware, a software or a combination thereof. In this description, the write mode unit 500 is exemplified as a single hardware, which will not limit the scope of the disclosure.

The write mode unit 500 may dynamically determine a write mode. The write mode may include a normal mode and a boost mode.

In the normal mode, the controller 130 may merge a plurality of write commands and may control the memory device 150 to perform a write operation of storing a plurality of data corresponding to the merged write commands into TLC blocks 551 included in the memory device 150.

In the boost mode, the controller 130 may control the memory device 150 to perform a write operation of storing data corresponding to each of the plurality of write commands into SLC blocks 553 included in the memory device 150.

The TLC blocks 551 and the SLC blocks 553 may be ones among the plurality of memory blocks 152, 154, 156.

The memory device 150 may be the same as the memory device 150 described with reference to FIGS. 1 to 4. In accordance with an embodiment of the disclosure, the memory device 150 may include both the TLC blocks 551 and the SLC blocks 553. Even though this description exemplifies the TLC blocks 551, a memory block of any multi-level cell capable of storing more bit values than a SLC may be applicable to an embodiment of the disclosure. Even though this description exemplifies the TLC blocks 551, an embodiment of the disclosure will not be limited to the TLC blocks 551.

The write mode unit 500 may have a write mode parameter table 510. The write mode unit 500 may generate a write mode result 517 through write mode parameters included in the write mode parameter table 510. Also, the write mode unit 500 may determine a write mode according to the write mode result 517. The controller 130 may control the memory device 150 to perform a write operation to the TLC blocks 551 or the SLC blocks 553 included in the memory device 150 according to determined write mode.

FIG. 5B is a diagram illustrating the write mode parameter table 510. The write mode parameter table 510 may include various write mode parameters such as a flush command count 511, a dummy data size 513, a required write performance 515 and so forth. An embodiment of the disclosure will not be limited to the write mode parameters described in the disclosure. The write mode parameter table 510 may include various parameters used for determining the boost mode and the normal mode. The write mode parameters may be set by a user of the memory system 100. The write mode parameter table 510 may include a single write mode parameter or a plurality of write mode parameters.

In a conventional memory system, when the flush command count 511 is great, e.g., close to, or larger than, a threshold level, high latency is required to merge a plurality of write commands and perform a write operation of storing data into the TLC blocks 551 in the normal mode. In accordance with an embodiment of the disclosure, when the flush command count 511 is greater than a predetermined threshold of flush command count, the write mode unit 500 may set the write mode to the boost mode. In the boost mode, the controller 130 may control the memory device 150 to perform a write operation to the SLC blocks 553 without merging the plurality of write commands. Therefore, the issue of the conventional memory system requiring high latency in the normal mode may be avoided in accordance with an embodiment of the disclosure.

When the dummy data size 513 is great, high latency is required to merge a plurality of write commands and perform a write operation of storing data into the TLC blocks 551 in the normal mode of a conventional memory system. In accordance with an embodiment of the disclosure, when the dummy data size 513 is greater than a predetermined threshold of dummy data size, the write mode unit 500 may set the write mode to the boost mode. In the boost mode, the controller 130 may control the memory device 150 to perform a write operation to the SLC blocks 553 without merging the plurality of write commands. Therefore, the problem of the prior art requiring high latency in the normal mode may be solved in accordance with an embodiment of the disclosure.

When the required write performance 515 is great, it is a problem that the low reliability of the TLC blocks 551 due to the characteristics of the TLC blocks 551 during a write operation to the TLC blocks 551 in the normal mode of a conventional memory system. The ‘required write performance’ indicates whether the reliability of the data to be written is high. In accordance with an embodiment of the disclosure, when the required write performance 515 is greater than a predetermined threshold of required write performance, the write mode unit 500 may set the write mode to the boost mode. In the boost mode, the controller 130 may control the memory device 150 to perform a write operation to the SLC blocks 553 having a high reliability without merging the plurality of write commands. Therefore, the low reliability in the normal mode as the problem of the prior art may be solved in accordance with an embodiment of the disclosure.

The write mode unit 500 may operate according to a logic value of a flag corresponding to the write mode result 517. For example, when the flag corresponding to the write mode result 517 is of a logical high value, the write mode unit 500 may set the write mode to the boost mode. For example, when the flag corresponding to the write mode result 517 is of a logical low value, the write mode unit 500 may set the write mode to the normal mode.

The above-described flags corresponding to the respective parameters are merely an example. In detail, the write mode unit 500 may set the write mode to the boost mode when one or more among the parameters, which are for outputting the write mode result 517, have greater value than a predetermined threshold. The write mode unit 500 may set the write mode to the normal mode when all the parameters, which are for outputting the write mode result 517, have less value than a predetermined threshold. That is, a method of representing whether a parameter has a greater value than a predetermined threshold may be various. For example, flags may be used for indicating whether the parameter is larger than the predetermined threshold.

A logic value of the flag may correspond to the write mode result 517. For example, the flag may include a resultant logic value of the logical OR operation against a logic value of the flag corresponding to the flush command count 511, a logic value of the flag corresponding to the dummy data size 513 and a logic value of the flag corresponding to the required write performance 515.

That is, the flag corresponding to the write mode result 517 may have a logical high value when any parameter satisfies a condition for turning on the boost mode among the parameters included in the write mode parameter table 510.

In other words, the write mode unit 500 may set the write mode to the boost mode when any parameter satisfies the condition for turning on the boost mode among the parameters included in the write mode parameter table 510.

When the flush command count 511 becomes low, e.g., sufficiently lower than a threshold level, problems of waste of large-sized memory blocks and frequent request of subsequent operations such as a garbage collection in the boost mode may be magnified despite above-described advantages of the boost mode. Therefore, in accordance with an embodiment of the disclosure, when the flush command count 511 becomes less than the predetermined threshold of the flush command count, the write mode unit 500 may set the write mode to the normal mode.

When the dummy data size 513 becomes low, problems of waste of large-sized memory blocks and frequent request of subsequent operations such as a garbage collection in the boost mode may be magnified despite above-described advantages of the boost mode. Therefore, in accordance with an embodiment of the disclosure, when the dummy data size 513 becomes less than the predetermined threshold of the dummy data size, the write mode unit 500 may set the write mode to the normal mode.

When the required write performance 515 becomes low, problems of waste of large-sized memory blocks and frequent request of subsequent operations such as a garbage collection in the boost mode may be magnified despite above-described advantages of the boost mode. Therefore, in accordance with an embodiment of the disclosure, when the required write performance 515 becomes less than the predetermined threshold of the required write performance, the write mode unit 500 may set the write mode to the normal mode.

In the normal mode, the controller 130 may merge the plurality of write commands. The controller 130 may control the memory device 150 to perform a write operation of storing a plurality of data corresponding to the merged write commands into the TLC blocks 551.

The flag corresponding to the write mode result 517 may include a resultant logic value of the logical OR operation against a logic value of the flag corresponding to the flush command count 511, a logic value of the flag corresponding to the dummy data size 513 and a logic value of the flag corresponding to the required write performance 515.

That is, the flag corresponding to the write mode result 517 may have a logical high value when any parameter satisfies a condition for turning on the normal mode among the parameters included in the write mode parameter table 510.

In other words, the write mode unit 500 may set the write mode to the normal mode when any parameter satisfies the condition for turning on the normal mode among the parameters included in the write mode parameter table 510.

FIG. 6 is a flowchart illustrating an operating method of the memory system for setting the write mode in accordance with an embodiment of the disclosure.

At step S611, the write mode unit 500 may refer to the write mode result 517 included in the write mode parameter table 510.

The write mode result 517 may represent a resultant logic value of the OR operation to logic values of the flags corresponding to the plurality of parameters (i.e., the flush command count 511, the dummy data size 513 and the required write performance 515) included in the write mode parameter table 510.

The flag corresponding to the write mode result 517 may have a logical high value when any parameter satisfies the condition for turning on the boost mode among the parameters included in the write mode parameter table 510.

The write mode unit 500 may set the write mode to the normal mode when any parameter satisfies the condition for turning on the normal mode among the parameters included in the write mode parameter table 510.

At step S613, the write mode unit 500 may determine through the write mode result 517 whether any parameter satisfies the condition for turning on the boost mode among the parameters included in the write mode parameter table 510.

When the flag corresponding to the write mode result 517 has a logical high value, the write mode unit 500 may set the write mode to the boost mode at step S615.

When the flag corresponding to the write mode result 517 has a logical low value, the write mode unit 500 may set the write mode to the normal mode at step S617.

At step S615, the write mode unit 500 may set the write mode to the boost mode according to the flag corresponding to the write mode result 517 and having a logical high value.

In the boost mode, the controller 130 may control the memory device 150 to perform a write operation of storing data corresponding to each of the plurality of write commands into SLC blocks 553 included in the memory device 150 without merging the plurality of write commands.

At step S617, the write mode unit 500 may set the write mode to the normal mode when the flag corresponding to the write mode result 517 includes a logical low value.

In the normal mode, the controller 130 may merge the plurality of write commands and may control the memory device 150 to perform a write operation of storing a plurality of data corresponding to the merged write commands into TLC blocks 551 included in the memory device 150.

At step S619, when the write operation is determined as not completed, the write mode unit 500 may refer to the write mode parameter table 510 repeatedly from step S611. That is, the write mode unit 500 may dynamically determine the write mode.

As described above, in accordance with an embodiment of the disclosure, the memory system may dynamically determine the write mode between the boost mode and the normal mode. Accordingly, overall performance of the memory system may be enhanced or improved by setting the write mode to the boost mode in the situation the advantages of the boost mode can be magnified while setting the write mode to the normal mode in the situation the advantages of the normal mode can be magnified.

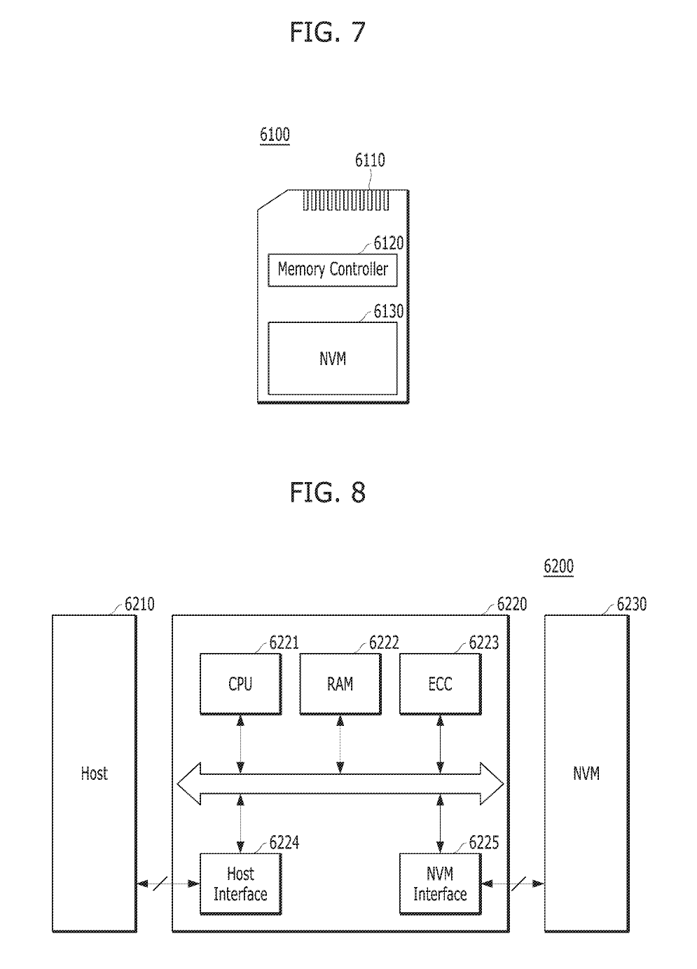

FIGS. 7 to 15 are diagrams schematically illustrating application examples of the data processing system of FIGS. 1 to 6 according to various embodiments.

FIG. 7 is a diagram schematically illustrating an example of the data processing system including the memory system in accordance with the embodiment. FIG. 7 schematically illustrates a memory card system to which the memory system in accordance with the embodiment is applied.

Referring to FIG. 7, the memory card system 6100 may include a memory controller 6120, a memory device 6130 and a connector 6110.

More specifically, the memory controller 6120, configured to access the memory device 6130, may be electrically connected to the memory device 6130 embodied by a nonvolatile memory. For example, the memory controller 6120 may be configured to control read, write, erase and background operations of the memory device 6130. The memory controller 6120 may be configured to provide an interface between the memory device 6130 and a host, and to use a firmware for controlling the memory device 6130. That is, the memory controller 6120 may correspond to the controller 130 of the memory system 110 described with reference to FIG. 1. The memory device 6130 may correspond to the memory device 150 of the memory system 110 described with reference to FIG. 1.

Thus, the memory controller 6120 may include a RAM, a processing unit, a host interface, a memory interface and an error correction unit. The memory controller 130 may further include the elements described in FIG. 1.

The memory controller 6120 may communicate with an external device, for example, the host 102 of FIG. 1 through the connector 6110. By the way of example but not limitation, as described with reference to FIG. 1, the memory controller 6120 may be configured to communicate with an external device under one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the embodiment may be applied to wired/wireless electronic devices or specific mobile electronic devices.

The memory device 6130 may be implemented by a nonvolatile memory. By the way of example but not limitation, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device. For example, the memory controller 6120 and the memory device 6130 may construct a solid state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., a SM and a SMC), a memory stick, a multimedia card (e.g., a MMC, a RS-MMC, a MMCmicro and an eMMC), an SD card (e.g., a SD, a miniSD, a microSD and a SDHC) and a universal flash storage (UFS).

FIG. 8 is a diagram schematically illustrating another example of the data processing system including a memory system, in accordance with the present embodiment.

Referring to FIG. 8, the data processing system 6200 may include a memory device 6230 having one or more nonvolatile memories and a memory controller 6220 for controlling the memory device 6230. The data processing system 6200 illustrated in FIG. 10 may serve as a storage medium such as a memory card (CF, SD, micro-SD or the like) or USB device, as described with reference to FIG. 1. The memory device 6230 may correspond to the memory device 150 in the memory system 110 described in FIG. 1. The memory controller 6220 may correspond to the controller 130 in the memory system 110 described in FIG. 1.

The memory controller 6220 may control a read, write or erase operation on the memory device 6230 in response to a request of the host 6210. The memory controller 6220 may include one or more CPUs 6221, a buffer memory such as RAM 6222, an ECC circuit 6223, a host interface 6224 and a memory interface such as an NVM interface 6225.

The CPU 6221 may control the operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or vice versa. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224. The memory controller 6220 may transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may achieve a wireless communication function with a mobile communication protocol such as WiFi or Long Term Evolution (LTE). The memory controller 6220 may be connected to an external device, e.g., the host 6210 or another external device, and then transmit/receive data to/from the external device. As the memory controller 6220 is configured to communicate with the external device through one or more of various communication protocols, the memory system and the data processing system in accordance with the present embodiment may be applied to a wired/wireless electronic device, particularly, a mobile electronic device.

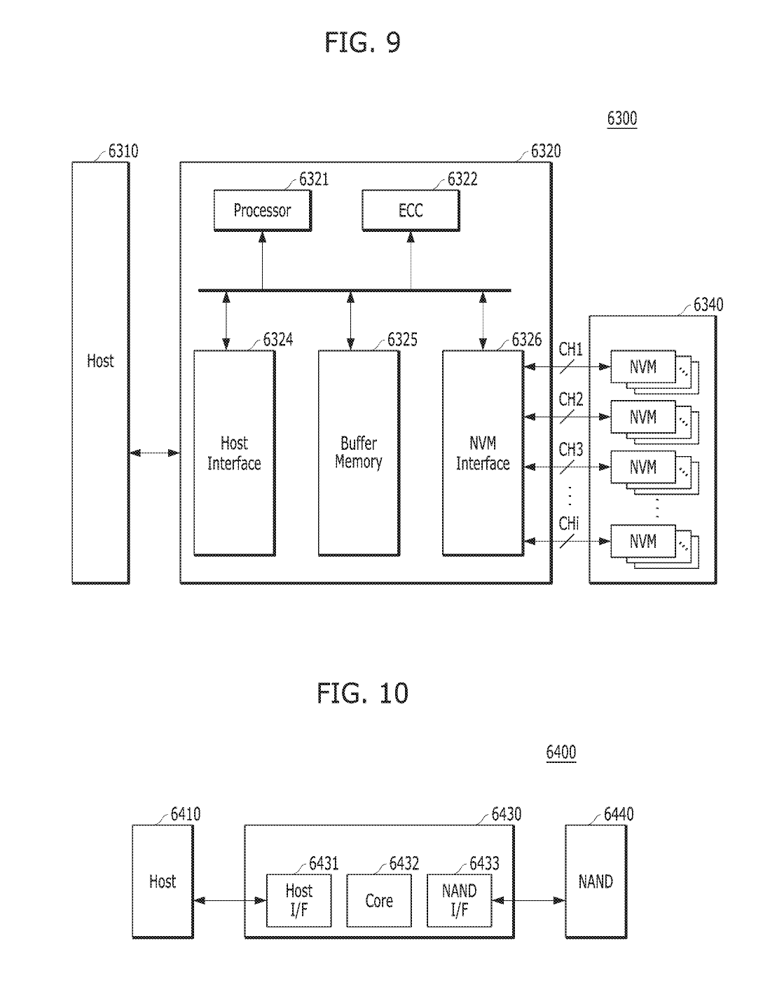

FIG. 9 is a diagram schematically illustrating another example of the data processing system Including the memory system in accordance with the present embodiment. FIG. 9 schematically illustrates an SSD to which the memory system in accordance with the present embodiment is applied.

Referring to FIG. 9, the SSD 6300 may include a controller 6320 and a memory device 6340 including a plurality of nonvolatile memories. The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface such as a nonvolatile memory interface 6326.

The buffer memory 6325 may temporarily store data provided from the host 6310 or data provided from a plurality of flash memories NVM included in the memory device 6340. Further, the buffer memory 6325 may temporarily store meta data of the plurality of flash memories NVM, for example, map data including a mapping table. The buffer memory 6325 may be embodied by volatile memories such as a DRAM, a SDRAM, a DDR SDRAM, a LPDDR SDRAM and a GRAM or nonvolatile memories such as a FRAM, a ReRAM, a STT-MRAM and a PRAM. For convenience of description, FIG. 9 illustrates that the buffer memory 6325 is included in the controller 6320. However, the buffer memory 6325 may locate outside the controller 6320.

The ECC circuit 6322 may calculate an ECC value of data to be programmed to the memory device 6340 during a program operation. The ECC circuit 6322 may perform an error correction operation on data read from the memory device 6340 based on the ECC value during a read operation. The ECC circuit 6322 may perform an error correction operation on data recovered from the memory device 6340 during a failed data recovery operation.

The host interface 6324 may provide an interface function with an external device such as the host 6310. The nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, RAID (Redundant Array of Independent Disks) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300, according to a plurality of RAID levels, e.g., RAID level information of the write command provided from the host 6310 in the SSDs 6300, to output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, to output data read from the selected SSDs 6300 to the host 6310.

FIG. 10 is a diagram schematically illustrating another example of the data processing system including the memory system in accordance with an embodiment. FIG. 10 schematically illustrates an embedded Multi-Media Card (eMMC) to which the memory system in accordance with an embodiment is applied.

Referring to FIG. 10, the eMMC 6400 may include a controller 6430 and a memory device 6440 embodied by one or more NAND flash memories. The controller 6430 may correspond to the controller 130 in the memory system 110 of FIG. 1. The memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface such as a NAND interface 6433.

The core 6432 may control the operations of the eMMC 6400. The host interface 6431 may provide an interface function between the controller 6430 and the host 6410. The NAND interface 6433 may provide an interface function between the memory device 6440 and the controller 6430. By the way of example but not limitation, the host interface 6431 may serve as a parallel interface such as the MMC interface as described with reference to FIG. 1. Furthermore, the host interface 6431 may serve as a serial interface, for example, UHS ((Ultra High Speed)-I/UHS-II) interface.

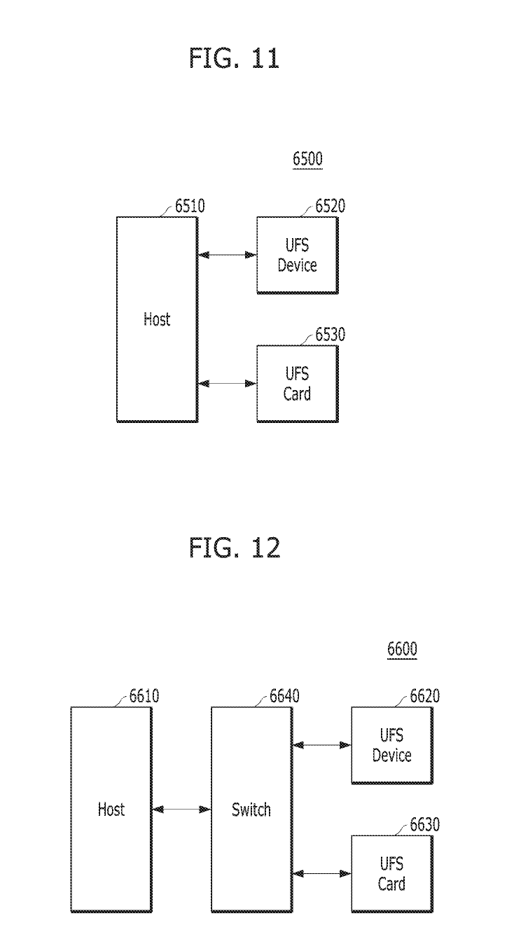

FIGS. 11 to 14 are diagrams schematically illustrating other examples of the data processing system including the memory system in accordance with an embodiment. FIGS. 11 to 14 schematically illustrate UFS (Universal Flash Storage) systems to which the memory system in accordance with an embodiment is applied.

Referring to FIGS. 11 to 14, the UFS systems 6500, 6600, 6700 and 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired/wireless electronic devices or particularly mobile electronic devices, the UFS devices 6520, 6620, 6720, 6820 may serve as embedded UFS devices, and the UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700, 6800 may communicate with external devices, for example, wired/wireless electronic devices or particularly mobile electronic devices through UFS protocols, and the UFS devices 6520, 6620, 6720, 6820 and the UFS cards 6530, 6630, 6730, 6830 may be embodied by the memory system 110 illustrated in FIG. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 10 to 12. The UFS cards 6530, 6630, 6730, 6830 may be embodied in the form of the memory card system 6100 described with reference to FIG. 7.

Furthermore, in the UFS systems 6500, 6600, 6700, 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through various protocols other than the UFS protocol, for example, an UFDs, a MMC, a SD, a mini-SD, and a micro-SD.

In the UFS system 6500 illustrated in FIG. 11, each of the host 6510, the UFS device 6520 and the UFS card 6530 may include UniPro. The host 6510 may perform a switching operation to communicate with the UFS device 6520 and the UFS card 6530. The host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410. A plurality of UFS cards may be connected in parallel or in the form of a star (e.g., a concentrated style where plural devices are coupled with a single main or central device) to the UFS device 6520 or connected in series or in the form of a chain to the UFS device 6520.

In the UFS system 6600 illustrated in FIG. 12, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

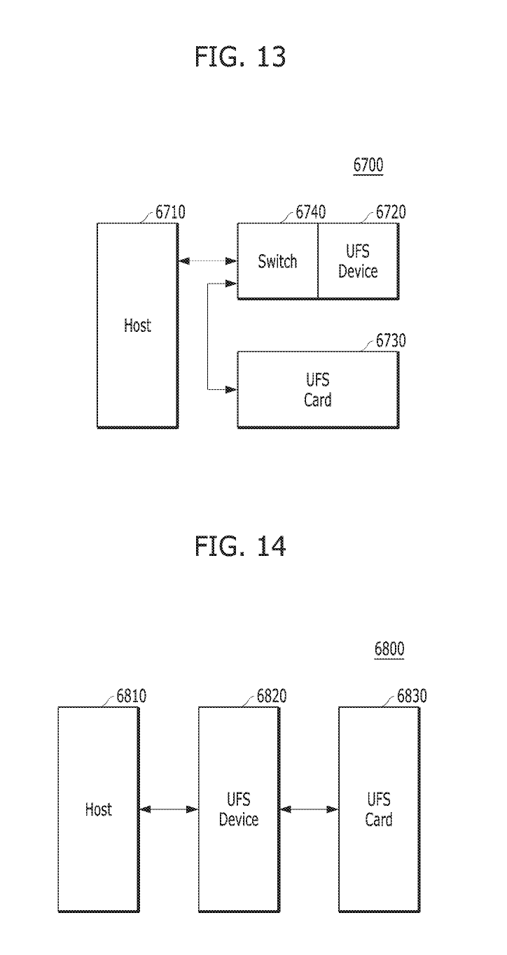

In the UFS system 6700 illustrated in FIG. 13, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In an embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 14, each of the host 6810, the UFS device 6820 and the UFS card 6830 may include M-PHY and UniPro. The UFS device 6820 may perform a switching operation to communicate with the host 6810 and the UFS card 6830. The UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In an embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810. A plurality of UFS cards may be connected in parallel or in the form of a star to the UFS device 6820, or connected in series or in the form of a chain to the UFS device 6820.

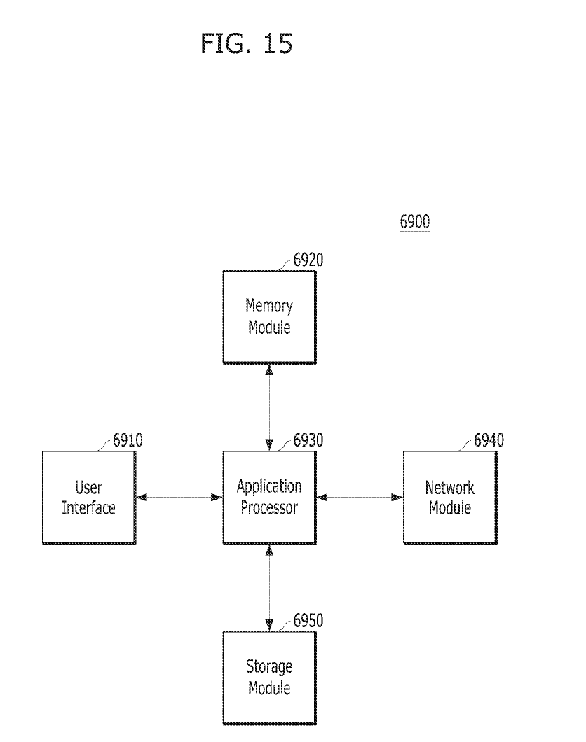

FIG. 15 is a diagram schematically illustrating another example of the data processing system including the memory system in accordance with an embodiment. FIG. 15 is a diagram schematically illustrating a user system to which the memory system in accordance with an embodiment is applied.

Referring to FIG. 15, the user system 6900 may include an application processor 6930, a memory module 6920, a network module 6940, a storage module 6950 and a user interface 6910.

More specifically, the application processor 6930 may control or drive components included in the user system 6900 such as an operating system (OS). The application processor 6930 may include controllers, interfaces and a graphic engine which may control the components included in the user system 6900. The application processor 6930 may be provided as a System-on-Chip (SoC).

The memory module 6920 may be used as a main memory, work memory, buffer memory or cache memory of the user system 6900. The memory module 6920 may include a volatile RAM such as a DRAM, a SDRAM, a DDR SDRAM, a DDR2 SDRAM, a DDR3 SDRAM, a LPDDR SDARM, a LPDDR3 SDRAM or a LPDDR3 SDRAM or a nonvolatile RAM such as a PRAM, a ReRAM, a MRAM or a FRAM. By the way of example but not limitation, the application processor 6930 and the memory module 6920 may be packaged and mounted, based on POP (Package on Package).

The network module 6940 may communicate with external devices. For example, the network module 6940 may not only support wired communication, but may also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or specific mobile electronic devices. Therefore, the memory system and the data processing system, in accordance with an embodiment of the disclosure, can be applicable to wired/wireless electronic devices. The network module 6940 may be included in the application processor 6930.

The storage module 6950 may store data, for example, data received from the application processor 6930, and then may transmit the stored data to the application processor 6930. The storage module 6950 may be implemented in a nonvolatile semiconductor memory device such as a phase-change RAM (PRAM), a magnetic RAM (MRAM), a resistive RAM (ReRAM), a NAND flash, a NOR flash and a 3D NAND flash. The storage module 6950 may be provided with a removable storage medium such as a memory card or external drive of the user system 6900. The storage module 6950 may correspond to the memory system 110 described with reference to FIG. 1. Furthermore, the storage module 6950 may be embodied in a SSD, an eMMC and an UFS as described above with reference to FIGS. 9 to 14.

The user interface 6910 may include interfaces for inputting data or commands to the application processor 6930 or outputting data to an external device. By the way of example but not limitation, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control the operations of the mobile electronic device. The network module 6940 may serve as a communication module for controlling wired/wireless communication with an external device. The user interface 6910 may display data processed by the processor 6930 on a display/touch module of the mobile electronic device. The user interface 6910 may support a function of receiving data entered from the touch panel.

While the invention has been described with respect to specific embodiments, it will be apparent to those skilled in the art that various changes and modifications may be made without departing from the spirit and scope of the invention as defined in the following claims.

What is claimed is:

1. A semiconductor memory system comprising:
a memory device including a first memory region and a second memory region; and
a controller suitable for:
merging a plurality of write commands,
controlling the memory device to perform a write operation of storing a plurality of data corresponding to the merged write commands into the first memory region in a normal mode, and
controlling the memory device to perform a write operation of storing data corresponding to each of the plurality of write commands into the second memory region in a boost mode.

2. The semiconductor memory system of claim 1,
wherein the controller includes a write mode unit, and
wherein the write mode unit is suitable for determining one between the boost mode and the normal mode according to a write mode result obtained from a write mode parameter table.

3. The semiconductor memory system of claim 2, wherein the write mode parameter table has as parameters for output of the write mode result:
a flush command count indicating how many times an operation corresponding to a flush command is completed;
a dummy data size indicating how many dummy data are required for the write operation, corresponding to the merged write commands, performed in either the first memory region or the second memory region; and
a required write performance indicating whether the reliability of the data to be written is high.

4. The semiconductor memory system of claim 3,
wherein the write mode unit determines the boost mode when one or more among the parameters for output of the write mode result have predetermined thresholds or more, and
wherein the write mode unit determines the normal mode when all of the parameters for output of the write mode result have less values than the predetermined thresholds.

5. The semiconductor memory system of claim 3,
wherein the write mode unit controls a flag corresponding to the flush command count to have a logical high value in the write mode parameter table when the flush command count is a predetermined threshold or more, and
wherein the write mode unit controls the flag corresponding to the flush command count to have a logical low value in the write mode parameter table when the flush command count is less than the predetermined threshold.

6. The semiconductor memory system of claim 3,
wherein the write mode unit controls a flag corresponding to the dummy data size to have a logical high value in the write mode parameter table when the dummy data size is a predetermined threshold or more, and
wherein the write mode unit controls the flag corresponding to the dummy data size to have a logical low value in the write mode parameter table when the dummy data size is less than the predetermined threshold.

7. The semiconductor memory system of claim 3,
wherein the write mode unit controls a flag corresponding to the required write performance to have a logical high value in the write mode parameter table when the required write performance is a predetermined threshold or more, and
wherein the write mode unit controls the flag corresponding to the required write performance to have a logical low value in the write mode parameter table when the required write performance is less than the predetermined threshold.

8. The semiconductor memory system of claim 3, wherein the write mode unit controls a flag corresponding to the write mode result to have a resultant logic value of an OR operation to logic values of flags included in the write mode parameter table.

9. The semiconductor memory system of claim 1,
wherein the first memory region includes memory cells between multi-level memory cells (MLCs) and triple level memory cells (TLCs), and
wherein the second memory region includes single level memory cells (SLCs).

10. An operating method of a semiconductor memory system, the operating method comprising:
merging a plurality of write commands, and controlling a memory device to perform a write operation of storing a plurality of data corresponding to the merged write commands into a first memory region included in the memory device in a normal mode, and
controlling the memory device to perform a write operation of storing data corresponding to each of the plurality of write commands into a second memory region included in the memory device in a boost mode.

11. The operating method of claim 10, further comprising determining one between the boost mode and the normal mode according to a write mode result obtained from a write mode parameter table.

12. The operating method of claim 11, wherein the write mode parameter table has as parameters for output of the write mode result:
a flush command count indicating how many times an operation corresponding to a flush command is completed;
a dummy data size indicating how many dummy data are required for the write operation, corresponding to the merged write commands, performed in either the first memory region or the second memory region; and
a required write performance indicating whether the reliability of the data to be written is high.

13. The operating method of claim 12, wherein the determining of one between the boost mode and the normal mode includes:
determining the boost mode when one or more among the parameters for output of the write mode result have predetermined thresholds or more; and
determining the normal mode when all the parameters for output of the write mode result have less values than the predetermined thresholds.

14. The operating method of claim 12, wherein the determining of one between the boost mode and the normal mode includes:
controlling a flag corresponding to the flush command count to have a logical high value in the write mode parameter table when the flush command count is a predetermined threshold or more; and
controlling the flag corresponding to the flush command count to have a logical low value in the write mode parameter table when the flush command count is less than the predetermined threshold.

15. The operating method of claim 12, wherein the determining of one between the boost mode and the normal mode includes:
controlling a flag corresponding to the dummy data size to have a logical high value in the write mode parameter table when the dummy data size is a predetermined threshold or more, and
controlling the flag corresponding to the dummy data size to have a logical low value in the write mode parameter table when the dummy data size is less than the predetermined threshold.

16. The operating method of claim 12, wherein the determining of one between the boost mode and the normal mode includes:
controlling a flag corresponding to the required write performance to have a logical high value in the write mode parameter table when the required write performance is a predetermined threshold or more, and
controlling the flag corresponding to the required write performance to have a logical low value in the write mode parameter table when the required write performance is less than the predetermined threshold.

17. The operating method of claim 12, wherein the determining of one between the boost mode and the normal mode includes controlling a flag corresponding to the write mode result to have a resultant logic value of an OR operation to logic values of flags included in the write mode parameter table.

18. The operating method of claim 10,
wherein the first memory region includes memory cells between multi-level memory cells (MLCs) and triple level memory cells (TLCs), and
wherein the second memory region includes single level memory cells (SLCs).

19. A memory system, comprising:
a memory device including a first memory region and a second memory region, which have different structures from each other; and
a controller suitable for dynamically determining a mode for a write operation in response to an entered write command with a data,
wherein the mode is determined based on at least one parameter set when a plurality of write commands are merged.
